(19) United States
(12) Patent Application Publication
(10) Pub. No.: US 2011/0318539 A1
(43) Pub. Date: Dec. 29, 2011

(54) PROCESS FOR PRODUCING FILM

(76) Inventors: Satoru Ozawa, Otake-shi (JP); Tadashi Nakamura, Otake-shi (JP); Eiko Okamoto, Otake-shi (JP); Katsuhiro Kojima, Otake-shi (JP)

(21) Appl. No.: 13/254,322

(22) PCT Filed: Mar. 2, 2010
(86) PCT No.: PCT/JP2010/001426

§ 371 Date: Sep. 1, 2011

(30) Foreign Application Priority Data
Mar. 3, 2009 (JP) 2009-049898
Jun. 26, 2009 (JP) 2009-152262

(51) Int. Cl. B32B 3/10; B29C 35/08

(52) U.S. Cl. 428/172; 264/496

(57) ABSTRACT

The present invention provides a method making it possible to stably prepare a transparent film in which a cured layer having a micro protrusion and recess face structure is formed on the surface of a base material film. The preparation method of the present invention includes a step of sandwiching an active energy beam-curable resin composition including a photopolymerization initiator which can initiate polymerization of a polymerizable compound by absorbing light between the surface of a base material film which is supported by a supporting film, and a mold which has an inverse structure of the micro protrusion and recess face structure on the surface; a step of obtaining the transparent film supported by the supporting film by means of irradiating the active energy beam-curable resin composition with ultraviolet rays from the supporting film side; and a step of separating the transparent film and the mold.

### TECHNICAL FIELD

The present invention relates to a transparent film having a micro protrusion and recess face structure on the surface thereof, and to a method of preparing said film.

Priority is claimed on Japanese Patent Application No. 2009-049898, filed Mar. 3, 2009, and Japanese Patent Application No. 2009-152262, filed Jun. 26, 2009, the contents of which are incorporated herein by reference.

### BACKGROUND ART

It is known that products having a micro protrusion and recess face structure of a period equal to or lower than a wavelength of visible rays on the surface thereof exhibit a reflection prevention effect, a lotus effect, and the like. In particular, a protrusion and recess face structure having a moth-eye structure is known as an effective means for preventing reflection since the refractive index continuously increases in this structure from the refractive index of air to the refractive index of the product.

A product having a micro protrusion and recess face structure on the surface thereof is obtained by forming a transparent film having a micro protrusion and recess face structure on the surface thereof on the surface of the body of the product, for example. A transparent film having a micro protrusion and recess face structure on the surface thereof can be prepared by a method including the following steps (i) to (iii), for example (Patent Document 1, for example).

(i) A step of sandwiching an ultraviolet-curable resin composition between a mold which includes an inverse structure of a micro protrusion and recess face structure on the surface thereof having been treated with an organic mold release agent, and a base material film serving as the body of a transparent film.

(ii) A step of obtaining a transparent film by irradiating the ultraviolet-curable resin composition with ultraviolet rays and forming a cured layer having a micro protrusion and recess face structure by means of curing the ultraviolet-curable resin composition.

(iii) A step of separating the mold and the transparent film.

In addition, in order to improve peelability between a mold and a polymer resin as a material to be processed, a mold release agent such as silicone oil, fluororesin solution, or the like is coated on the mold, or functional groups are provided on the mold surface so as to react with the mold release agent, whereby the mold surface is treated (Patent Document 2).

However, it was found that a transparent film having a micro protrusion and recess face structure on the surface thereof cannot be stably prepared since the organic mold release agent on the mold surface deteriorates and is degraded soon by the emitted ultraviolet rays in step (ii).

In particular, it was found that when a film including a (meth)acrylic resin (hereinafter, referred to as an “acrylic film”) or a film including a triacetyl cellulose film (hereinafter, referred to as a “TAC film”) is used as the base material film, the organic mold release agent on the mold surface markedly deteriorates and is degraded, so a transparent film having a micro protrusion and recess face structure on the surface thereof cannot be stably prepared.

As a method of preparing a transparent film having a micro protrusion and recess face structure on the surface thereof, for example, a method (a roll-to-roll method) of obtaining the transparent film is known which includes sandwiching an active energy beam-curable resin composition between the surface of a base material film and the surface of a roll-like mold while the belt-like base material film is moved along the surface of the rotating roll-like mold which has an inverse structure of the micro protrusion and recess face structure on the surface thereof, curing the active energy beam-curable resin composition by irradiating the composition with the active energy beam, and forming a cured layer to which the inverse structure of the roll-like mold has been transferred (for example, Patent Document 3).

When the transparent film is used for optical products, for example, when the film is attached to the optical products, it is preferable that there be no difference in refractive index between the body of the product and the base material film, that is, it is preferable that the body of the product and the base material film include the same material. Accordingly, when the material of the body of the product is a (meth)acrylic resin, a film including a (meth)acrylic resin (hereinafter, referred to as an “acrylic film”) is used as the base material film, and when the material of the body of the product is triacetyl cellulose, a film including triacetyl cellulose (hereinafter, referred to as a “TAC film”) is used as the base material film.

However, the acrylic film and TAC film exhibit weak tensile strength at a temperature (for example, 50° C. to 150° C.) in curing the active energy beam-curable resin composition, and stretch little. Therefore, when the acrylic film or TAC film is used as the base material film in a roll-to-roll method, there is a problem in that the base material film in which the cured layer is formed may be broken due to the tension applied to the base material film.

### PRIOR ART REFERENCES

### Patent Documents

[Patent Document 1] JP-A-2007-076089
[Patent Document 2] JP-A-2007-326367
[Patent Document 3] JP-A-2002-192540

### SUMMARY OF THE INVENTION

### Problem to be Solved by the Invention

The present invention provides a method for stably preparing a transparent film in which a cured layer having a micro protrusion and recess face structure is formed on the surface of a base material film such as an acrylic film or a TAC film.

The present invention also provides a method for preparing a continuous transparent film in which a cured layer having a micro protrusion and recess face structure is formed on the surface of a base material film having weak tensile strength, without breakage of the film, and provides a continuous film without breakage even if a cured layer having a micro protrusion and recess face structure has been formed on the surface of the base material film having weak tensile strength.

### Means for Solving the Problem

The method of preparing a transparent film having a micro protrusion and recess face structure on the surface thereof of the present invention inyloves preparing a transparent film in which a cured layer has a micro protrusion and recess face structure formed on the surface of a base material film. The method includes (I) a step of sandwiching an active energy beam-curable resin composition including a polymerizable compound and a photopolymerization initiator which can initiate polymerization of the polymerizable compound by absorbing light of a wavelength of 340 nm or longer between the surface of a base material film which is supported from the back surface side thereof by a supporting film having 10% or lower light transmissivity in a wavelength range of 190 to 310 nm and having 60% or higher light transmissivity in a wavelength range of 340 to 900 nm, and a mold which has an inverse structure of the micro protrusion and recess face structure on the surface thereof having been treated with an organic mold release agent, (II) a step of obtaining the transparent film which is supported from the back surface side thereof by the supporting film by means of irradiating the active energy beam-curable resin composition with ultraviolet rays from the supporting film side and forming the cured layer by curing the active energy beam-curable resin composition, and (III) a step of separating the transparent film which is supported from the back surface side thereof by the supporting film and the mold.

The method of preparing the transparent film having the micro protrusion and recess face structure on the surface thereof of the present invention involves preparing a transparent film in which a cured layer having the micro protrusion and recess face structure is formed on the surface of a base material film. The method includes, while a base material film which is supported from a back surface thereof by a supporting film having a tensile strength at 70° C. of greater than 40 MPa and has a tensile strength at 70° C. of 5 MPa to 40 MPa is moved along a surface of a rotating roll-like mold which has an inverse structure of the micro protrusion and recess face structure on a surface thereof, sandwiching an active energy beam-curable resin composition between a surface of the base material film and a surface of the roll-like mold; and obtaining a transparent film which is supported from the back surface thereof by the supporting film by forming a cured layer to which the inverse structure has been transferred, by means of curing the active energy beam-curable resin composition by irradiating the active energy beam-curable resin composition with active energy beams.

It is preferable that the base material film include a (meth)acrylic resin or triacetyl cellulose.

It is preferable that adhesion between the base material film and the supporting film be 0.005 to 50 N/25 mm.

In the transparent film of the present invention, the cured layer having the micro protrusion and recess face structure is formed on the surface of the base material film which is supported from the back surface side thereof by the supporting film, and a tensile strength at 70° C. of the base material film is 5 MPa or greater.

It is preferable that adhesion between the base material film and the supporting film be 0.005 to 50 N/25 mm.

It is preferable that the base material film include a (meth)acrylic resin or triacetyl cellulose.

### Effects of the Invention

According to the method of preparing the transparent film having the micro protrusion and recess face structure on the surface thereof of the present invention, it is possible to stably prepare the transparent film in which the cured layer having the micro protrusion and recess face structure is formed on the surface of the base material film of a (meth)acrylic resin, triacetyl cellulose, or the like.

According to the method of preparing the transparent film of the invention, it is possible to continuously prepare a transparent film in which the cured layer having the micro protrusion and recess face structure is formed on the surface of a base material film having a weak tensile strength, without breakage of the transparent film.

The transparent film of the present invention continues without breakage even if the cured layer having the micro protrusion and recess face structure is formed on the surface of the base material film having a weak tensile strength.

### BRIEF DESCRIPTION OF DRAWINGS

FIG. 1 is a C1s spectrum determined by X-ray photoemission spectroscopy (XPS) of both of peeled layers of a transparent film including a PET film in a base material film.

FIG. 2 is an electron micrograph of both peeled layers of the transparent film having the PET film in the base material film.

FIG. 3 is a chart showing an example of a transmission spectrum of a polyethylene terephthalate film.

FIG. 4 is a chart showing an example of a transmission spectrum of an acrylic film.

FIG. 5 is a chart showing an example of a transmission spectrum of a TAC film.

FIG. 6 is a cross-sectional view showing steps for preparing a mold having anodized alumina on the surface thereof.

FIG. 7 is a schematic configuration view showing an example of a device for preparing the transparent film.

FIG. 8 is a cross-sectional view showing an example of the transparent film.

FIG. 9 is a schematic configuration view showing an example of a device for roughening the surface of the acrylic film.

### EMBODIMENTS OF THE INVENTION

In the present specification, a “(meth)acrylate” means an acrylate or a methacrylate, and “(meth)acryl” means acryl or methacryl. “Transparent” means that light at least having a wavelength of 400 to 1170 nm is permeated. “Active energy beams” means visible rays, ultraviolet rays, electron rays, plasma, heat rays (infrared rays or the like), and the like.

<Method of Preparing Transparent Film>

The method of preparing a transparent film having a micro protrusion and recess face structure of the surface thereof (hereinafter, a “transparent film having a micro protrusion and recess face structure on the surface thereof” is simply referred to as a “transparent film”) of the present invention involves preparing a transparent film in which a cured layer having a micro protrusion and recess face structure is formed on the surface of a base material film. The method includes the following steps (I) to (III).

(I) A step of sandwiching an active energy beam-curable resin composition including a polymerizable compound and a photopolymerization initiator which can initiate polymerization of the polymerizable compound by absorbing light of a wavelength of 340 nm or longer between the surface of a base material film which is supported from the back surface side thereof by a supporting film having 10% or lower light transmissivity in a wavelength range of 190 nm to 310 nm and having 60% or higher light transmissivity in a wavelength range of 340 nm to 900 nm, and a mold which has an inverse structure of the micro protrusion and recess face structure on the surface thereof having been treated with an organic mold release agent

(II) A step of obtaining the transparent film which is supported from the back surface side thereof by the supporting film by means of irradiating the active energy beam-curable resin composition with ultraviolet rays from the supporting film side and forming the cured layer by curing the active energy beam-curable resin composition

(III) A step of separating the transparent film which is supported from the back surface side thereof by the supporting film and the mold

The method of preparing the transparent film of the present invention involves preparing a transparent film in which a cured layer having a micro protrusion and recess face structure is formed on the surface of the base material film. In the method, while the base material film which is supported from the back surface side thereof by a supporting film is moved along the surface of a rotating roll-like mold having an inverse structure of the micro protrusion and recess face structure on the surface thereof, the following steps (IV) to (VII) are performed.

(IV) A step of sandwiching an active energy beam-curable resin composition between the surface of the base material film and the surface of the roll-like mold

(V) A step of obtaining a transparent film which is supported from the back surface side thereof by a supporting film by forming a cured layer to which the inverse structure has been transferred, by means of curing the active energy beam-curable resin composition by irradiating the active energy beam-curable resin composition with active energy beams

(VI) A step of separating the transparent film supported by the supporting film and the roll-like mold

(VII) A step of peeling off the supporting film from the back surface of the base material film optionally

(Supporting Film)

The supporting film is a transparent resin film satisfying the following conditions (α) and (β). (α) A light transmissivity is 10% or lower in a wavelength range of 190 nm to 310 nm. (β) A light transmissivity is 60% or higher in a wavelength range of 340 nm to 900 nm.

If the transmissivity of light having a wavelength of 310 nm or shorter is 10% or lower, it is possible to reduce the light (ultraviolet rays) of a wavelength deteriorating and degrading an organic mold release agent on the mold surface. It is preferable that the transmissivity of light in a wavelength range of 190 nm to 310 nm be 5% or lower.

If the transmissivity of light having a wavelength of 340 nm or longer is 60% or higher, it is possible to initiate the polymerization of a polymerizable compound by using a photopolymerization initiator included in the active energy beam-curable resin composition. It is preferable that the light transmissivity be 70% or higher in a wavelength range of 340 nm to 900 nm.

The supporting film of the present invention is a long resin film having a tensile strength at 70° C. greater than 40 MPa. If the tensile strength at 70° C. of the supporting film is greater than 40 MPa, it is possible to suppress the breakage of the base material film caused at the temperature in curing the active energy beam-curable resin composition. The tensile strength at 70° C. of the supporting film is preferably 45 MPa or greater, and more preferably 60 MPa or greater.

(Tensile Strength at 70° C.)

The strength of each film is calculated using a tensile tester (manufactured by Shimadzu Corporation., AG-1S10 kN, for example). As an example of the test method, a sample is cut into a strip shape having a width of about 5 mm and gripped by a chuck so as to yield a valid test length of 20 mm. Thereafter, a thermostatic bath (manufactured by Shimadzu Corporation., TCL-N220) is adjusted to a predetermined temperature, and then the tensile strength is measured at a tensile rate of 40 mm/min, whereby a stress-strain curve is obtained.

Examples of the supporting film satisfying the above conditions include a polyethylene terephthalate (hereinafter, referred to as PET) film, a polycarbonate film, and the like. A resin film which satisfies the above conditions by including an ultraviolet ray absorbent absorbing a specific wavelength of ultraviolet rays may also be included in the examples.

It is preferable that the supporting film be the PET film in respect of the strength required for supporting the film and cost. The supporting film may be a monolayer film or a laminate film.

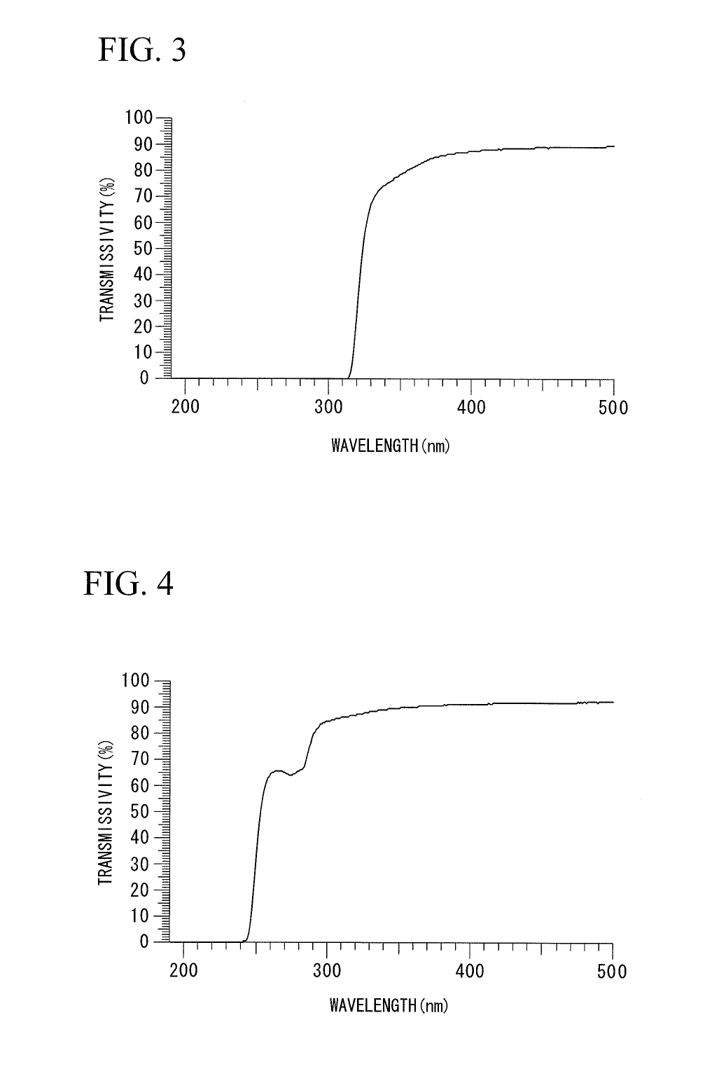

FIG. 3 shows an example of a transmittance spectrum of a PET film (manufactured by TOYOBO CO., LTD., product name: A4300, thickness: 188 μm). FIG. 3 clearly shows that in the PET film, the transmissivity of light having a wavelength of 310 nm or shorter is 10% or lower, and the transmissivity of light having a wavelength of 340 nm or longer is 60% or higher.

(Base Material Film)

The base material film is a long resin film having a tensile strength at 70° C. of 5 MPa or greater. The base material film is preferably a long resin film having a tensile strength at 70° C. of 5 MPa to 40 MPa. If the tensile strength at 70° C. of the base material film is 5 MPa or greater, the strength of the transparent film from which the supporting film has been peeled becomes sufficient.

The supporting film is attached to the back surface of the base material film by an adhesive or the like, whereby the base material film is supported from the back surface side thereof by the supporting film.

The adhesion between the base material film and the supporting film is preferably 0.005 to 50 N/25 mm. If the adhesion is 0.005 N/25 mm or greater, the base material film is sufficiently supported by the supporting film. If the adhesion is 50 N/25 mm or less, the supporting film is easily peeled off from the back surface of the base material film. The adhesion between the base material film and the supporting film is more preferably 0.01 to 10 N/25 mm.

The adhesion between the base material film and the supporting film is measured by setting a sample cut into 25 mm×30 cm in a Tensilon tester for tensile strength test (manufactured by ORIENTEC Co., LTD, Tensilon RTC-1210, for example) and using 10 N of load cells, based on JIS Z0237. After the supporting film is peeled, an adhesive may be applied to the supporting film side or to the base material film side. When the adhesive is applied to the base material film side, the film can be used as an adhesive-applied moth-eye (a structure in which a plurality of bumps (convex portions) having an approximately conical shape, pyramidal shape, or the like is arranged on the surface of the structure at intervals which are equal to or smaller than the wavelength of visible rays) film. For example, by attaching the moth-eye film to a surface desired to prevent reflection, a surface desired to impart water repellency, and a surface desired to impart hydrophilicity, it is possible to easily impart functions to the surface.

As the base material film, an acrylic film or a TAC film is preferable.

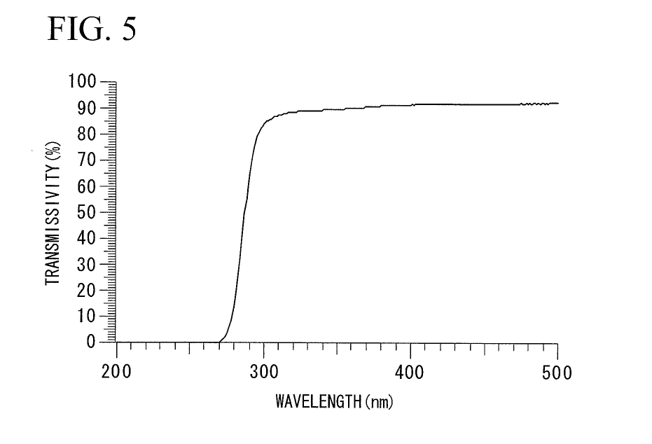

FIG. 4 shows an example of the transmittance spectrum of the acrylic film (manufactured by Mitsubishi Rayon Co., Ltd, product name: Acrypren® HBK002, thickness: 200 μm), and FIG. 5 shows an example of the transmittance spectrum of the TAC film (manufactured by FUJIFILM Corporation, product name: T80SZ, thickness: 83 μm). FIGS. 4 and 5 clearly show that the light transmissivity of the acrylic film and TAC film exceeds 10% even at a wavelength of 310 nm or shorter.

As the (meth)acrylic resin configuring the acrylic film, a (meth)acrylic resin composition (C) including 0 to 80% by mass of a (meth)acrylic resin (A) and 20 to 100% by mass of a rubber-containing polymer (B) is preferable.

If the amount of the rubber-containing polymer (B) is too small, the tensile strength of the acrylic film is reduced, and adhesiveness with respect to the cured layer tends to deteriorate.

The (meth)acrylic resin (A) is a homopolymer or a copolymer which includes 50 to 100% by mass of a unit derived from an alkyl methacrylate having an alkyl group including 1 to 4 carbon atoms and 0 to 50% by mass of a unit derived from other vinyl monomers that can be copolymerized with the above unit.

As the alkyl methacrylate having an alkyl group including 1 to 4 carbon atoms, a methyl methacrylate is most preferable.

Examples of the other vinyl monomers include alkyl acrylates (methyl acrylate, ethyl acrylate, butyl acrylate, propyl acrylate, 2-ethylhexyl acrylate, and the like), alkyl methacrylates (butyl methacrylate, propyl methacrylate, ethyl methacrylate, methyl methacrylate, and the like), aromatic vinyl compounds (styrene, α-methylstyrene, para-methylstyrene, and the like), and vinyl cyanide compounds (acrylonitrile, methacrylonitrile, and the like).

The (meth)acrylic resin (A) can be prepared by a well-known suspension polymerization, emulsion polymerization, bulk polymerization, and the like.

The (meth)acrylic resin (A) is available as a Dianal® BR series manufactured by Mitsubishi Rayon Co., Ltd, and Acrypet® manufactured by Mitsubishi Rayon Co., Ltd.

The rubber-containing polymer (B) may be polymerized in 2 or more steps, in 3 or more steps, or 4 or more steps. Examples of the rubber-containing polymer (B) include rubber-containing polymers disclosed in JP-A-2008-208197, JP-A-2007-327039, JP-A-2006-289672, and the like.

Specific examples of the rubber-containing polymer (B) include the following polymers (B1) to (B3).

Polymer (B1): a polymer obtained by polymerizing a monomer (B1-2) including at least an alkyl methacrylate having an alkyl group with 1 to 4 carbon atoms as a constituent component, in the presence of a rubber polymer obtained by polymerizing a monomer (B1-1) including at least an alkyl acrylate having an alkyl group with 1 to 8 carbon atoms and/or an alkyl methacrylate having an alkyl group with 1 to 4 carbon atoms and a graft crossing agent as constituent components. The monomers (B1-1) and (B1-2) may be collectively polymerized or may be polymerized in 2 or more of separate steps.

Polymer (B2): (3) a polymer obtained by polymerizing a monomer (B2-3) including at least an alkyl methacrylate having an alkyl group with 1 to 4 carbon atoms as a constituent component, in the presence of (2) a rubber polymer which is obtained by polymerizing a monomer (B2-2) having a composition different from that of a monomer (B2-1). The monomer (B2-2) is polymerized in the presence of (1) a polymer which is obtained by polymerizing the monomer (B2-1) including at least an alkyl acrylate having an alkyl group with 1 to 8 carbon atoms and/or an alkyl methacrylate having an alkyl group with 1 to 4 carbon atoms and a graft crossing agent as constituent components, and includes at least an alkyl acrylate having an alkyl group with 1 to 8 carbon atoms and/or an alkyl methacrylate having an alkyl group with 1 to 4 carbon atoms and a graft crossing agent as constituent components.

Polymer (B3): a polymer obtained by polymerizing (3) a monomer (B3-3) including at least an alkyl acrylate having an alkyl group with 1 to 8 carbon atoms and/or an alkyl methacrylate having an alkyl group with 1 to 4 carbon atoms and a graft crossing agent as constituent components and by further polymerizing (4) a monomer (B3-4) including at least an alkyl methacrylate having an alkyl group with 1 to 4 carbon atoms as constituent components. The monomers are polymerized in the presence of (2) a rubber polymer obtained by polymerizing a monomer (B3-2) including at least an alkyl acrylate having an alkyl group with 1 to 8 carbon atoms and a graft crossing agent as constituent components, in the presence of (1) a polymer obtained by polymerizing a monomer (B3-1) including at least an alkyl acrylate having an alkyl group with 1 to 8 carbon atoms and/or an alkyl methacrylate having an alkyl group with 1 to 4 carbon atoms and a graft crossing agent as constituent components.

The mass average particle size of the rubber-containing polymer (B) is preferably 0.01 to 0.5 μm, and in respect of transparency of an optical acrylic film, the particle size is more preferably 0.3 μm or smaller, and still more preferably 0.15 μm or smaller.

The (meth)acrylic resin composition (C) may optionally include an ultraviolet ray absorbent, a stabilizer, a lubricant, a process aid, a plasticizer, an impact resistance aid, a mold release agent, and the like.

Examples of the method of preparing the acrylic film include melt extrusion methods such as a well-known melt casting method, a T-die method, and an inflation method. The T-die method is preferable in terms of economic efficiency.

The thickness of the acrylic film is preferably 10 to 500 μm, more preferably 15 to 400 μm, and still more preferably 20 to 300 μm, in terms of physical properties of the film.

Examples of the TAC film include commercially available optical TAC films.

The thickness of the TAC film is preferably 10 to 500 μm, more preferably 15 to 400 μm, and still more preferably 20 to 300 μm, in terms of physical properties of the film.

When the transparent film of the present invention is used outdoors, for example, the base material film is also required to have sufficient weather resistance. Though the film may be subjected to outdoor exposure to check the weather resistance, subjecting the film to a sunshine weather meter (abbreviated as SWOM hereinafter, manufactured by Suga Test Instruments Co., Ltd., model name: S80, for example) test is more efficient. The SWOM test may be performed for 660 hours, which is sufficient test hours, and the condition of the test is as follows, for example.

Conditions: temperature of a BPT black panel of 63±3° C., internal bath temperature of 50±5%, precipitation for 18 minutes within 120 minutes, a cycle of 78 hours.

As described above, in order to suppress the degradation of the mold release agent caused by ultraviolet rays in preparing the transparent film or to prevent the breakage of the base material film, it is possible to use the PET film, for example. Therefore, by using a PET film (WE97A manufactured by Mitsubishi Plastics, Inc., thickness of 38 μm) as the base material film, a transparent film in which a cured layer having a micro protrusion and recess face structure had been formed on the surface of the PET film was prepared, and the SWOM test was performed.

As a result, the cured layer having the micro protrusion and recess face structure was visually confirmed to be peeled off from the PET film when 390 hours had elapsed.

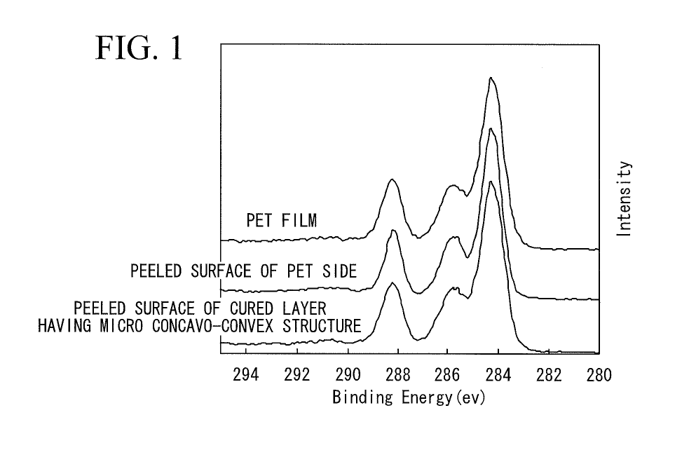

In order to find the cause of the above result, the peeled surface was analyzed. Both the peeled surfaces (the cured layer side having the micro protrusion and recess face structure and the PET film side) were measured by X-ray photoelectron spectroscopy (ESCA LAB220iXL manufactured by VG Scientific Ltd.) under conditions of a 200 W monochromatic X-ray source (ALKα) and Pass Energy of 200 eV. As a result, atomic percentages of both the surfaces coincided with each other, and as shown in FIG. 1, the C1s spectrum was similar to PET.

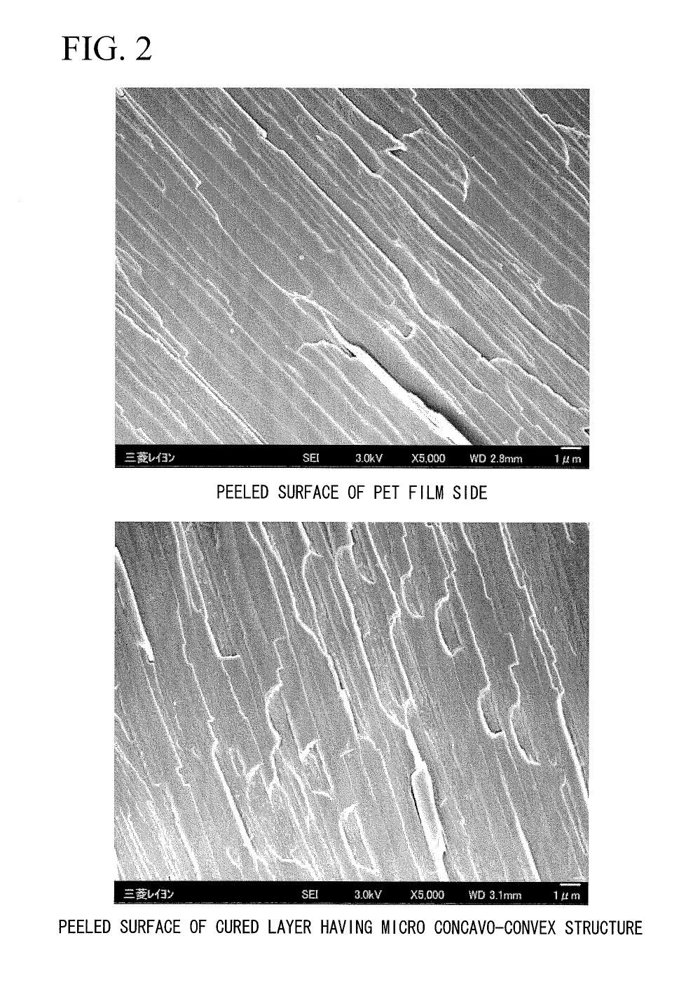

In addition, both the peeled surfaces were observed using an electron microscope (manufactured by JEOL Ltd., JSM-7400F) under a condition of an accelerating voltage of 3.00 kV. As a result, the same shape was observed on both the peeled surfaces as shown in FIG. 2.

From the above results, it is possible to estimate that the peeling was caused by cohesive peeling of the PET film. That is, it can be mentioned that the PET deteriorated, embrittled, and was peeled due to the weather resistance test.

On the other hand, when the same SWOM test was performed when a transparent film in which an acrylic film (manufactured by Mitsubishi Rayon Co., Ltd, product name: Acrypren® HBK003, thickness: 100 μm) having a roughened surface was used as the base material film, and a cured layer having the micro protrusion and recess face structure was formed on the base material film, peeling was not confirmed even after 660 hours had elapsed.

Accordingly, even in terms of the weather resistance, the use of the acrylic film or the TAC film as the base material film is suitable.

In order to improve the adhesiveness between the base material film and the cured layer having the micro protrusion and recess face structure, it is preferable to roughen the surface of the base material. Examples of a method of roughening the surface of the base material film include a blast treatment, an embossing process, a corona treatment, a plasma treatment, and the like.

The blast treatment is a method of forming a convex and concave shape by cutting the surface of the base material film. Examples of the blast treatment include sandblasting in which the surface of the base material film is cut by being brought into contact with sand, scratch blasting in which the surface of the base material film is scratched by, for example, a needle having a sharp edge to form the convex and concave shape, a hairline process, and the like.

The embossing process is a method in which a molten thermoplastic resin is sandwiched between a mirror surface roll and an embossing roll, followed by cooling, whereby the convex and concave shape is formed.

The corona treatment is a method in which corona discharge is caused by applying an output of a high frequency and high voltage supplied from a high frequency power source between a discharge electrode and a treatment roll, and the base material film is caused to pass the state of corona discharge to modify the surface of the base material film.

The plasma treatment is a method in which gas is excited in a vacuum by using the high frequency power source and the like as a trigger to create a highly reactive plasma state, and then the base material film is brought into contact with the plasma state to modify the surface of the base material film.

As a method of roughening the surface, the plasma treatment and the embossing process are preferable in that arithmetic mean roughness Ra is easily increased, and the scratch blast and the hairline process are more preferable in that a deeper and denser convex and concave structure can be formed.

The arithmetic mean roughness Ra of the roughened surface is preferably 0.06 to 0.4 μm, and more preferably 0.09 to 0.4 μm. If the arithmetic mean roughness Ra is 0.06 μm or more, the depth of convexities and concavities on the surface of the base material film become sufficient, and sufficient adhesiveness with respect to the cured layer is obtained. If the arithmetic mean roughness Ra is 0.4 μm or less, the convexities and concavities on the surface of the base material film do not become too deep, and decrease in the strength of the base material film is suppressed. A maximum height Ry of the base material film is preferably 3.0 to 8.0 μm, and more preferably 4.0 to 8.0 μm. If the maximum height Ry is 3.0 μm or more, the adhesiveness with respect to the cured layer is further improved. If the maximum height Ry is 8.0 μm or less, the decrease in the strength of the base material film is further suppressed.

An external haze is preferably 3.0 to 20.0%, and more preferably 6.0 to 12.0%. The external haze is based on the stipulation of JIS K₇₁₃₆ and calculated by the following formula (1).

External haze=a haze of a base material film which has been subjected to surface roughening−a haze of a base material film which has not yet been subjected to surface roughening (1)

If the external haze is 3.0% or more, the depth of the convexities and concavities on the surface of the base material film becomes sufficient, and the adhesiveness with respect to the cured layer is further improved. If the external haze is 12.0% or less, the convexities and concavities on the surface of the base material film do not become too deep, and the decrease in the strength of the base material film is further suppressed.

(Mold) The mold is the one in which an inverse structure corresponding to the micro protrusion and recess face structure on the surface of the base material film obtained finally (hereinafter, referred to as an inverse micro protrusion and recess face structure) is present on the surface of the mold body, and the surface is treated with an organic mold release agent.

Examples of a material of the mold body include metals (including those having an oxidized layer on the surface thereof), quartz, glass, resins, ceramics, and the like.

Examples of the shape of the mold body include a roll shape, a circular tube shape, a flat panel shape, a sheet shape, and the like.

The roll shape of mold may be those in which the micro protrusion and recess face structure is formed on the surface of the barrel shape or cylinder shape of mold body, and may be those which are obtained by forming the micro protrusion and recess face structure on the surface of the flat panel shape or sheet shape of mold body and rounding the resultant into a barrel shape.

Examples of the method of preparing the mold include the following (X) or (Y) method. The method (X) is preferable in that the mold with a large area can be made and the mold is prepared easily.

(X) A method of forming anodized alumina having a plurality of micropores (concave portion) on the surface of the mold body including aluminum

(Y) A method of directly forming a micro protrusion and recess face structure on the surface of the mold body through lithography, an electron beam lithography, laser interferometry, and the like

As the method (X), a method having the following steps (a) to (e) is preferable.

(a) A step of forming an oxidized layer by anodizing aluminum in an electrolyte solution under constant voltage

(b) A step of forming a micropore-generating point of anodization by removing the oxidized layer

(c) A step of forming an oxidized layer having micropores at the micropore-generating point by re-anodizing aluminum in the electrolyte solution

(d) A step of enlarging the diameter of the micropores

(e) A step of repeating steps (c) and (d)

Step (a):

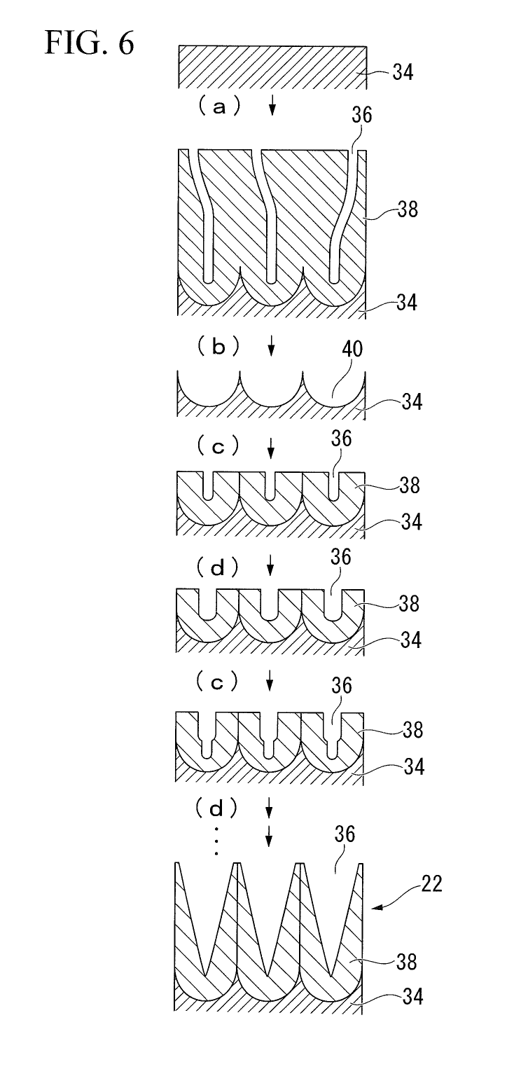

As shown in FIG. 6, when an aluminum 34 is anodized, an oxidized layer 38 having micropores 36 is formed.

The purity of aluminum is preferably 99% or higher, more preferably 99.5% or higher, and particularly preferably 99.8% or higher. If the purity of aluminum is low, during anodization, the concave and convex structure of a size scattering visible rays is formed due to the segregation of impurities, or the regularity of the micropores obtained by the anodization deteriorates, in some cases.

Examples of the electrolyte solution include oxalic acid, sulfuric acid, and the like.

Case of Using Oxalic Acid as Electrolyte Solution:

The concentration of the oxalic acid is preferably 0.7 M or lower. If the concentration of the oxalic acid exceeds 0.7 M, current values become too high, whereby the surface of the oxidized layer is roughened in some cases.

When a formation voltage is 30 to 60 V, it is possible to obtain anodized alumina having micropores of a high regularity having a period of 100 nm. The regularity tends to decrease if the formation voltage is higher or lower than this range.

The temperature of the electrolyte solution is preferably 60° C. or lower, and more preferably 45° C. or lower. If the temperature of the electrolyte solution exceeds 60° C., a phenomenon of so-called “scorching” occurs, whereby the micropores are broken or the regularity of the micropores deteriorates in some cases since the surface thereof is molten.

Case of Using Sulfuric Acid as Electrolyte Solution:

The concentration of the sulfuric acid is preferably 0.7 M or less. If the concentration of the sulfuric acid exceeds 0.7 M, current values become too high, whereby the constant voltage cannot be retained in some cases.

When the formation voltage is 25 V to 30 V, it is possible to obtain an anodized alumina having micropores of a high regularity having a period of 63 nm. The regularity tends to decrease if the formation voltage is higher or lower than this range.

The temperature of the electrolyte solution is preferably 30° C. or lower, and more preferably 20° C. or lower. If the temperature of the electrolyte solution exceeds 30° C., a phenomenon of so-called “scorching” occurs, whereby the micropores are broken or the regularity of the micropores deteriorates in some cases since the surface thereof is molten.

Step (b):

As shown in FIG. 6, the oxidized layer 38 is temporarily removed to obtain a micropore generating point 40 of anodization, whereby it is possible to improve the regularity of the micropores.

Examples of a method of removing the oxidized layer include a method of removing the oxidized layer by dissolving the oxidized layer in a solution which selectively dissolves the oxidized layer while not dissolving aluminum.

Examples of the solution include a mixed solution including chromic acid/phosphoric acid and the like.

Step (c):

As shown in FIG. 6, if the aluminum 34 from which the oxidized layer has been removed is re-anodized, the oxidized layer 38 having cylindrical micropores 36 is formed.

Anodization may be performed under the same condition as in step (a). The longer the time of the anodization, the deeper micropores can be obtained.

Step (d):

As shown in FIG. 6, a treatment (hereinafter, referred to as a micropore diameter enlarging treatment) of enlarging the diameter of the micropores 36 is performed. The micropore diameter enlarging process is a process of enlarging the diameter of micropores obtained by anodization by means of dipping the oxidized layer in a solution for dissolving the oxidized layer. Examples of the solution include an aqueous phosphoric acid solution of about 5% by mass and the like.

The longer the time of the micropore diameter enlarging treatment, the larger the micropore diameter.

Step (e):

As shown in FIG. 6, if the anodization of step (c) and the micropore diameter enlarging treatment of step (d) are repeated, an anodized alumina (a porous oxidized layer of aluminum (alumite)) having the micropores 36 with a shape in which the diameter of the pores continuously decreases in a depth direction from an opening portion is formed, whereby a mold 22 having the micro protrusion and recess face structure on the surface thereof is obtained.

The number of times of repetition is preferably 3 or more in total, and more preferably 5 or more. If the number of times of repetition is 2 or less, the diameter of micropores decreases discontinuously, and as a result, an effect of reducing reflectance of the cured layer which has been prepared using the anodized alumina having those micropores becomes insufficient.

Examples of the shape of the micropores 36 include an approximately conical shape, a pyramidal shape, and the like.

The average period between the micropores 36 is equal to or less than the wavelength of visible rays, that is, 400 nm or less. The average period between the micropores 36 is preferably 25 nm or more.

The depth of the micropores 36 is preferably 100 to 500 nm, and more preferably 150 to 400 nm.

The aspect ratio (depth of micropores/width of opening portion of micropores) of the micropores 36 is preferably 1.5 or more, and more preferably 2.0 or more.

The surface of a cured layer 20 formed by transferring the micropores 36 shown in FIG. 6 becomes a so-called moth-eye structure.

The surface of the mold 22 may be treated with a mold release agent so as to be easily separated from the cured layer. Examples of the mold release agent include a silicone resin, a fluororesin, a fluorine compound, and the like, and the fluorine compound having a hydrolysable silyl group is preferable in that this compound is excellent in a mold releasing property and adhesiveness to the mold. Examples of commercial products of the fluorine compound include a fluoroalkylsilane, and an “OPTOOL” series manufactured by DAIKIN INDUSTRIES, Ltd.

(Organic Mold Release Agent)

Organic mold release agents easily deteriorate and are degraded by ultraviolet rays, and the shorter the wavelength of light, the more marked the deterioration and degradation become.

Examples of the organic mold release agent include a silicone resin, a fluororesin, a fluorine compound, and the like, and the fluorine compound having a hydrolysable silyl group is preferable in that this compound is excellent in a mold releasing property and adhesiveness to the mold. Examples of commercial products of the fluorine compound include a fluoroalkylsilane, and an “OPTOOL” series manufactured by DAIKIN INDUSTRIES, Ltd, and the like.

(Active Energy Beam-Curable Resin Composition)

The active energy beam-curable resin composition includes a polymerizable compound and a polymerization initiator.

Examples of the polymerizable compound include monomers having a radically polymerizable bond and/or a cationically polymerizable bond in a molecule, oligomers, reactive polymers, and the like.

The active energy beam-curable resin composition may include nonreactive polymers and an active energy beam sol-gel reactive composition.

Examples of the monomers having the radically polymerizable bond include monofunctional monomers and multifunctional monomers.

Examples of the monofunctional monomers include (meth)acrylate derivatives such as methyl (meth)acrylate, ethyl (meth)acrylate, propyl (meth)acrylate, n-butyl (meth)acrylate, i-butyl (meth)acrylate, s-butyl (meth)acrylate, t-butyl (meth)acrylate, 2-ethylhexyl (meth)acrylate, lauryl (meth)acrylate, alkyl (meth)acrylate, tridecyl (meth)acrylate, stearyl (meth)acrylate, cyclohexyl (meth)acrylate, benzyl (meth)acrylate, phenoxyethyl (meth)acrylate, isobornyl (meth)acrylate, glycidyl (meth)acrylate, tetrahydrofurfuryl (meth)acrylate, allyl (meth)acrylate, 2-hydroxyethyl (meth)acrylate, hydroxypropyl (meth)acrylate, 2-methoxyethyl (meth)acrylate, 2-ethoxyethyl (meth)acrylate, and the like; (meth)acrylic acid, (meth)acrylonitrile; styrene derivatives such as styrene, α-methylstyrene, and the like; and (meth)acrylamide derivatives such as (meth)acrylamide, N-dimethyl (meth)acrylamide, N-diethyl (meth)acrylamide, dimethylaminopropyl (meth)acrylamide, and the like. These may be used alone or in combination of 2 or more kinds thereof.

Examples of the multifunctional monomers include bifunctional monomers such as ethylene glycol di(meth)acrylate, tripropylene glycol di(meth)acrylate, ethylene oxide isocyanurate-modified di(meth)acrylate, triethylene glycol di(meth)acrylate, diethylene glycol di(meth)acrylate, neopentyl glycol di(meth)acrylate, 1,6-hexanediol di(meth)acrylate, 1,5-pentanediol di(meth)acrylate, 1,3-butylene glycol di(meth)acrylate, polybutylene glycol di(meth)acrylate, 2,2-bis(4-(meth)acryloxypolyethoxy phenyl)propane, 2,2-bis(4-(meth)acryloxyethoxyphenyl)propane, 2,2-bis(4-(3-(meth)acryloxy-2-hydroxypropoxy)phenyl)propane, 1,2-bis(3-(meth)acryloxy-2-hydroxypropoxy)ethane, 1,4-bis(3-(meth)acryloxy-2-hydroxypropoxy)butane, dimethylol tricyclodecane di(meth)acrylate, ethylene oxide adduct of bisphenol A di(meth)acrylate, propylene oxide adduct of bisphenol A di(meth)acrylate, hydroxy pivalic acid neopentyl glycol di(meth)acrylate, divinyl benzene, methylenebisacrylamide, and the like; trifunctional monomers such as pentaerythritol tri(meth)acrylate, trimethylolpropane tri(meth)acrylate, trimethylolpropane ethylene oxide-modified tri(meth)acrylate, trimethylolpropane propylene oxide-modified triacrylate, trimethylolpropane ethylene oxide-modified triacrylate, ethylene oxide isocyanurate-modified tri(meth)acrylate, and the like; tetra- or higher functional monomers such as a condensation reaction mixture of succinic acid/trimethylolethane/acrylic acid, dipentaerythritol hexa(meth)acrylate, dipentaerythritol penta(meth)acrylate, ditrimethylolpropane tetraacrylate, tetramethylolmethane tetra(meth)acrylate, and the like; bi- or higher functional urethane acrylate, bi- or higher functional polyester acrylate, and the like. These may be used alone or in combination of 2 or more kinds thereof.

Examples of the monomers having a cationically polymerizable bond include monomers having an epoxy group, an oxetanyl group, an oxazolyl group, a vinyloxy group, and the like, and the monomers having an epoxy group are particularly preferable.

Examples of the oligomers or reactive polymers include unsaturated polyesters such as a condensate of an unsaturated dicarboxylic acid and a polyhydric alcohol and the like; polyester (meth)acrylate, polyether (meth)acrylate, polyol (meth)acrylate, epoxy (meth)acrylate, urethane (meth)acrylate, cationic polymerization types of epoxy compounds, homopolymers or copolymers of the above-described monomers having the radically polymerizable bond at a side chain, and the like.

Examples of the nonreactive polymers include acrylic resins, styrene-based resins, polyurethane, cellulose-based resins, polyvinyl butyral, polyester, thermoplastic elastomers, and the like.

Examples of the active energy beam sol-gel reactive composition include alkoxy silane compounds, alkyl silicate compounds, and the like.

Examples of the alkoxy silane compound include compounds of the following formula (2)

R¹ₓSi(OR²)_{y} (2)

Here, R¹ and R² represent alkyl groups having 1 to 10 carbon atoms respectively, and x and y represent an integer satisfying the relationship of x+y=4.

Examples of the alkoxysilane compound include tetramethoxysilane, tetra-1-propoxysilane, tetra-n-propoxysilane, tetra-n-butoxysilane, tetra-sec-butoxysilane, tetra-t-butoxysilane, methyltriethoxysilane, methyltripropoxysilane, methyltributoxysilane, dimethyldimethoxysilane, dimethyldiethoxysilane, trimethylethoxysilane, trimethylmethoxysilane, trimethylpropoxysilane, trimethylbutoxysilane, and the like.

Examples of the alkyl silicate compound include compounds of the following formula (3).

R³O[Si(OR⁵)(OR⁶)O]_{z}R⁴ (3)

Here, R³ to R⁶ represent alkyl groups having 1 to 5 carbon atoms respectively, and z represents an integer of 3 to 20.

Examples of the alkyl silicate compound include methyl silicate, ethyl silicate, isopropyl silicate, n-propyl silicate, n-butyl silicate, n-pentyl silicate, acetyl silicate, and the like.

When a photocuring reaction is used, as a photopolymerization initiator, those that can initiate the polymerization of polymerizable compounds by absorbing light having a wavelength of 340 nm or longer is used.

Examples of the photopolymerization initiator that can initiate the polymerization of polymerizable compounds by absorbing light having a wavelength of 340 nm or longer include carbonyl compounds such as benzoin, benzoin methyl ether, benzoin ethyl ether, benzoin isopropyl ether, benzoin isobutyl ether, benzyl, benzophenone, p-methoxybenzophenone, 2,2-diethoxyacetophenone, α,α-dimethoxy-α-phenylacetophenone, methyl phenyl glyoxylate, ethyl phenyl glyoxylate, 4,4-bis(dimethylamino)benzophenone, 2-hydroxy-2-methyl-1-phenylpropan-1-one, and the like; sulfur compounds such as tetramethylthiuram monosulfide, tetramethylthiuram disulfide, and the like; 2,4,6-trimethylbenzoyl diphenyl phosphinoxide, benzoyl diethoxy phosphinoxide, IRGACURE® 184, 819, 2022, and 2100 manufactured by Ciba Specialty Chemicals Ltd, and the like. These may be used alone or in combination of 2 or more kinds thereof.

When an electron beam curing reaction is used, examples of the polymerization initiator include thioxanthone such as benzophenone, 4,4-bis(diethylamino)benzophenone, 2,4,6-trimethylbenzophenone, methyl ortho-benzoylbenzoate, 4-phenylbenzophenone, t-butyl anthraquinone, 2-ethyl anthraquinone, 2,4-diethyl thioxanthone, isopropyl thioxanthone, 2,4-dichloro thioxanthone, and the like; acetophenones such as diethoxy acetophenone, 2-hydroxy-2-methyl-1-phenylpropan-1-one, benzyl dimethyl ketal, 1-hydroxycyclohexyl-phenyl ketone, 2-methyl-2-morpholino(4-thiomethylphenyl)propan-1-one, 2-benzyl-2-dimethylamino-1-(4-morpholinophenyl)butane, and the like; benzoin ethers such as benzoin methyl ether, benzoin ethyl ether, benzoin isopropyl ether, benzoin isobutyl ether, and the like; acyl phosphinoxide such as 2,4,6-trimethylbenzoyl diphenyl phosphinoxide, bis(2,6-dimethoxybenzoyl)-2,4,4-trimethylpentyl phosphinoxide, bis(2,4,6-trimethylbenzoyl)-phenyl phosphinoxide, and the like; methylbenzoyl formate, 1,7-bisacrydinylheptane, 9-phenylacrydine, and the like. Theses may used alone or in combination of 2 or more kinds thereof.

When a thermal curing reaction is used, examples of the thermopolymerization initiator include organic peroxides such as a methyl ethyl ketone peroxide, benzoyl peroxide, dicumyl peroxide, t-butyl hydroperoxide, cumene hydroperoxide, t-butyl peroxy octoate, t-butyl peroxy benzoate, lauroyl peroxide, and the like; azo-based compounds such as azobisisobutyronitrile, and the like; and redox polymerization initiators obtained by combining amines such as N,N-dimethylaniline, N,N-dimethyl-p-toluidine, and the like with the organic peroxides.

The amount of the polymerization initiator is preferably 0.1 to 10 parts by mass based on 100 parts by mass of the polymerizable compound. If the amount of the polymerization initiator is less than 0.1 parts by mass, it is difficult for polymerization to proceed. If the amount of the polymerization initiator exceeds 10 parts by mass, the cured layer is colored or a mechanical strength decreases in some cases.

The active energy beam-curable resin composition may optionally include an antistatic agent, a mold release agent, additives such as fluorine compounds for improving an antifouling property, microparticles, and a small amount of solvents.

(Hydrophobic Material)

In order to create 90° or more of a water contact angle of the surface of the moth-eye structure of the cured layer, it is preferable to use compositions including fluorine-containing compounds or silicone-based compounds, as the active energy beam-curable resin composition that can form hydrophobic materials.

Fluorine-Containing Compound:

As the fluorine-containing compound, compounds having a fluoroalkyl group represented by the following formula (4) are preferable.

—(CF₂)ₙ—X (4)

Here, X represents a fluorine atom or a hydrogen atom, n represents an integer of 1 or greater. n is preferably 1 to 20, more preferably 3 to 10, and particularly preferably 4 to 8.

Examples of the fluorine-containing compound include fluorine-containing monomers, fluorine-containing silane coupling agents, fluorine-containing surfactants, fluorine-containing polymers, and the like.

Examples of the fluorine-containing monomer include fluoroalkyl group-substituted vinyl monomers, fluoroalkyl group-substituted ring opening polymerizable monomers, and the like.

Examples of the fluoroalkyl group-substituted vinyl monomers include fluoroalkyl group-substituted (meth)acrylate, fluoroalkyl group-substituted (meth)acrylamide, fluoroalkyl group-substituted vinyl ether, fluoroalkyl group-substituted styrene, and the like.

Examples of the fluoroalkyl group-substituted ring opening polymerizable monomers include fluoroalkyl group-substituted epoxy compounds, fluoroalkyl group-substituted oxetane compounds, fluoroalkyl group-substituted oxazoline compounds, and the like.

As the fluorine-containing monomer, the fluoroalkyl group-substituted (meth)acrylate is preferable, and compounds of the following formula (5) are particularly preferable.

CH₂═C(R⁷)C(O)O—(CH₂)ₘ—(CF₂)ₚ—X (5)

Here, R⁷ represents a hydrogen atom or methyl group, X represents a hydrogen atom or a fluorine atom, m represents an integer of 1 to 6, which is preferably 1 to 3 and more preferably 1 or 2, and p represents an integer of 1 to 20, which is preferably 3 to 10 and more preferably 4 to 8.

As the fluorine-containing silane coupling agent, the fluoroalkyl group-substituted silane coupling agents are preferable, and compounds of the following formula (6) are particularly preferable.

(R^{f})ₐR⁸_{b}SiY_{c} (6)

R^{f} represents a fluorine-substituted alkyl group having 1 to 20 carbon atoms, which may include 1 or more ether bonds or ester bonds. Examples of R^{f} include a 3,3,3-trifluoropropyl group, tridecafluoro-1,1,2,2-tetrahydrooctyl group, 3-trifluoromethoxypropyl group, 3-trifluoroacetoxypropyl group, and the like.

R⁸ represents an alkyl group having 1 to 10 carbon atoms. Examples of R⁸ include a methyl group, an ethyl group, a cyclohexyl group, and the like.

Y represents a hydroxyl group or a hydrolysable group.

Examples of the hydrolysable group include an alkoxy group, a halogen atom, R⁹C(O)O(here, R⁹ represents a hydrogen atom or an alkyl group having 1 to 10 carbon atoms), and the like.

Examples of the alkoxy group include methoxy groups, ethoxy groups, propyloxy groups, i-propyloxy groups, butoxy groups, i-butoxy groups, t-butoxy groups, pentyloxy groups, hexyloxy groups, cyclohexyloxy groups, heptyloxy groups, octyloxy groups, 2-ethylhexyloxy groups, nonyloxy groups, decyloxy groups, 3,7-dimethyloctyloxy groups, lauryloxy groups, and the like.

Examples of the halogen atom include Cl, Br, I, and the like.

Examples of R⁹C(O)O include CH₃C(O)O, C₂H₅C(O)O, and the like.

a, b, and c satisfy a+b+c=4 and represent integers satisfying a≧1 and c≧1. It is preferable that a=1, b=0, and c=3.

Examples of the fluorine-containing silane coupling agent include 3,3,3-trifluoropropyl trimethoxysilane, 3,3,3-trifluoropropyl triacetoxysilane, dimethyl-3,3,3-trifluoropropyl methoxysilane, tridecafluoro-1,1,2,2-tetrahydrooctyl triethoxysilane, and the like.

Examples of the fluorine-containing surfactant include fluoroalkyl group-containing anionic surfactants, fluoroalkyl group-containing cationic surfactants, and the like.

Examples of the fluoroalkyl group-containing anionic surfactant include fluoroalkyl carboxylic acid having 2 to 10 carbon atoms or a metal salt thereof, disodium perfluorooctanesulfonyl glutamate, sodium 3-[omega-fluoroalkyl(C₆ to C₁₁)oxy]-1-alkyl(C₃ to C₄) sulfonate, sodium 3-[omega-fluoroalkanoyl(C₆ to C₈)—N-ethylamino]-1-propane sulfonate, fluoroalkyl(C₁₁ to C₂₀) carboxylic acid or a metal salt thereof, perfluoroalkyl carboxylic acid(C₇ to C₁₃) or a metal salt thereof, perfluoroalkyl(C₄ to C₁₂) sulfonic acid or a metal salt thereof, perfluorooctanesulfonic acid diethanolamide, N-propyl-N-(2-hydroxyethyl)perfluorooctanesulfonamide, perfluoroalkyl(C₆ to C₁₀)sulfonamidopropyl trimethyl ammonium salt, perfluoroalkyl(C₆ to C₁₀)—N-ethylsulfonyl glycine salt, monoperfluoroalkyl(C₆ to C₁₆)ethyl phosphoric acid ester, and the like.

Examples of the fluoroalkyl group-containing cationic surfactant include fluoroalkyl group-containing primary, secondary, or tertiary aliphatic amino acids, quaternary aliphatic ammonium salts such as a perfluorolakyl(C₆ to C₁₀)sulfonamidopropyl trimethyl ammonium salt and the like, benzalkonium salts, benzetonium chloride, pyridinium salts, imidazolinium salts, and the like.

Examples of the fluorine-containing polymer include polymers of fluoroalkyl group-containing monomers, copolymers of fluoroalkyl group-containing monomers and poly(oxyalkylene) group-containing monomers, copolymers of fluoroalkyl group-containing monomers and cross-linking reactive group-containing monomers, and the like. The fluorine-containing polymer may be a copolymer obtained by copolymerization with other copolymerizable monomers.

As the fluorine-containing polymer, copolymers of fluoroalkyl group-containing monomers and poly(oxyalkylene) group-containing monomers are preferable.

As the poly(oxyalkylene) group, groups represented by the following formula (7) are preferable.

—(OR¹⁰)_{q}— (7)

Here, R¹⁰ represents an alkylene group having 2 to 4 carbon atoms, and q represents an integer of 2 or greater. Examples of R¹⁰ include —CH₂CH₂—, —CH₂CH₂CH₂—, —CH(CH₃)CH₂—, —CH(CH₃)CH(CH₃)—, and the like.

The poly(oxyalkylene) group may be a group including the same oxyalkylene units (OR¹⁰), or may be a group including 2 or more kinds of oxyalkylene units (OR¹⁰). The sequence of the 2 or more kinds of oxyalkylene units (OR¹⁰) may be a block or random.

Silicone-Based Compound:

Examples of the silicone-based compound include (meth)acrylic acid-modified silicone, a silicone resin, a silicone-based silane coupling agent, and the like.

Examples of the (meth)acrylic acid-modified silicone include silicone (di)(meth)acrylate, and the like.

(Hydrophilic Material)

In order to create 25° or less of a water contact angle of the surface of the moth-eye structure of the cured layer, it is preferable to use compositions including the following polymerizable compounds, as the active energy beam-curable resin composition that can form hydrophilic materials.

Polymerizable compounds including 10 to 50% by mass of tetra- or higher multifunctional (meth)acrylate, 30 to 80% by mass of bi- or higher functional hydrophilic (meth)acrylate, and 0 to 20% by mass of monofunctional monomer, which yield 100% by mass in total.

Examples of the tetra- or higher multifunctional (meth)acrylate include ditrimethylolpropane tetra(meth)acrylate, pentaerythritol tetra(meth)acrylate, pentaerythritol ethoxy tetra(meth)acrylate, dipentaerythritol hydroxy penta(meth)acrylate, dipentaerythritol hexa(meth)acrylate, a condensation reaction mixture of succinic acid/trimethylolethane/acrylic acid (1:2:4 in a molar ratio), urethane acrylates (manufactured by DAICEL-CYTEC Company LTD.: EBECRYL 220, EBECRYL 1290, EBECRYL1290K, EBECRYL 5129, EBECRYL 8210, EBECRYL 8301, and KRM 8200), polyether acrylates (manufactured by DAICEL-CYTEC Company LTD.: EBECRYL 81), modified epoxy acrylates (manufactured by DAICEL-CYTEC Company LTD.: EBECRYL 3416), polyester acrylates (manufactured by DAICEL-CYTEC Company LTD.: EBECRYL 450, EBECRYL 657, EBECRYL 800, EBECRYL 810, EBECRYL 811, EBECRYL 812, EBECRYL 1830, EBECRYL 845, EBECRYL 846, and EBECRYL 1870), and the like. These may be used alone or in combination of 2 or more kinds thereof.

As the tetra- or higher multifunctional (meth)acrylate, penta- or higher multifunctional (meth)acrylate is more preferable.

The proportion of the tetra- or higher multifunctional (meth)acrylate is preferably 10 to 50% by mass, more preferably 20 to 50% by mass, and particularly preferably 30 to 50% by mass, in terms of water resistance and resistance to chemicals. If the proportion of the tetra- or higher multifunctional (meth)acrylate is 10% by mass or more, the elastic modulus increases, whereby abrasion resistance is improved. If the proportion of the tetra- or higher multifunctional (meth)acrylate is 50% by mass or less, it is difficult for small cracks to occur on the surface, whereby the exterior barely becomes defective.

Examples of the bi- or higher functional hydrophilic (meth)acrylate include multifunctional acrylates having long-chain polyethylene glycol, such as ARONIX M-240 and ARONIX M-260 (manufactured by TOAGOSEI CO., LTD.), NK ester AT-20E and NK ester ATM-35E (manufactured by Shin-Nakamura Chemical Co., Ltd.), and the like, polyethylene glycol dimethacrylate, and the like. These may be used alone or in combination of 2 or more kinds thereof.

In the polyethylene glycol dimethacrylate, the total of the average number of repeating units of a polyethylene glycol chain in one molecule is preferably 6 to 40, more preferably 9 to 30, and particularly preferably 12 to 20. If the average number of the repeating units of a polyethylene glycol chain is 6 or more, hydrophilicity becomes sufficient, which leads to the improvement of the antifouling property. If the average number of the repeating units of a polyethylene glycol chain is 40 or less, compatibility with the tetra- or higher multifunctional (meth)acrylate becomes excellent, whereby it is difficult for the active energy beam-curable resin composition to be separated.

The proportion of the bi- or higher functional hydrophilic (meth)acrylate is preferably 30 to 80% by mass, and more preferably 40 to 70% by mass. If the proportion of the bi- or higher functional hydrophilic (meth)acrylate is 30% by mass or more, hydrophilicity becomes sufficient, whereby the antifouling property is improved. If the proportion of the bi- or higher functional hydrophilic (meth)acrylate is 80% by mass or less, the elastic modulus increases, whereby the abrasion resistance is improved.

As the monofunctional monomer, hydrophilic monofunctional monomers are preferable.

Examples of the hydrophilic monofunctional monomer include monofunctional (meth)acrylates having a polyethylene glycol chain in an ester group, such as M-20G, M-90G, M-230G (manufactured by Shin-Nakamura Chemical Co., Ltd.) and the like, monofunctional (meth)acrylates having a hydroxyl group in an ester group, such as hydroxyalkyl (meth)acrylate and the like, monofunctional acrylamides, and cationic monomers such as methacrylamidopropyl trimethylammonium methylsulfate, methacryloyloxyethyl trimethylammonium methylsulfate, and the like.

In addition, as the monofunctional monomer, viscosity adjustors such as acryloyl morpholine, vinyl pyrrolidone, and the like, adhesiveness improving agents such as acryloyl isocyanates which improve the adhesiveness with respect to the base material, and the like may be used.

The proportion of the monofunctional monomer is preferably 0 to 20% by mass, and more preferably 5 to 15% by mass. The use of the monofunctional monomer improves the adhesiveness between a member and the cured resin. If the proportion of the monofunctional monomer is 20% by mass or less, the antifouling property or the abrasion resistance is sufficiently expressed without shortage of the tetra- or higher multifunctional (meth)acrylate or the bi- or higher functional hydrophilic (meth)acrylate.

The monofunctional monomer may be mixed with the active energy beam-curable resin composition at 0 to 35 parts by mass, as a polymer of low polymerization degree, which is obtained by (co)polymerizing 1 or 2 or more kinds of the monofunctional monomer. Examples of the polymer of low polymerization degree include monofunctional (meth)acrylates having a polyethylene glycol chain in an ester group, such as M-230G (manufactured by Shin-Nakamura Chemical Co., Ltd.) and the like, a copolymerized oligomer (manufactured by MRC UNITEC CO., LTD., MG polymer) obtained by copolymerization with methacrylamidopropyl trimethylammonium methylsulfate in a ratio of 40/60, and the like.

(Device for Preparation)

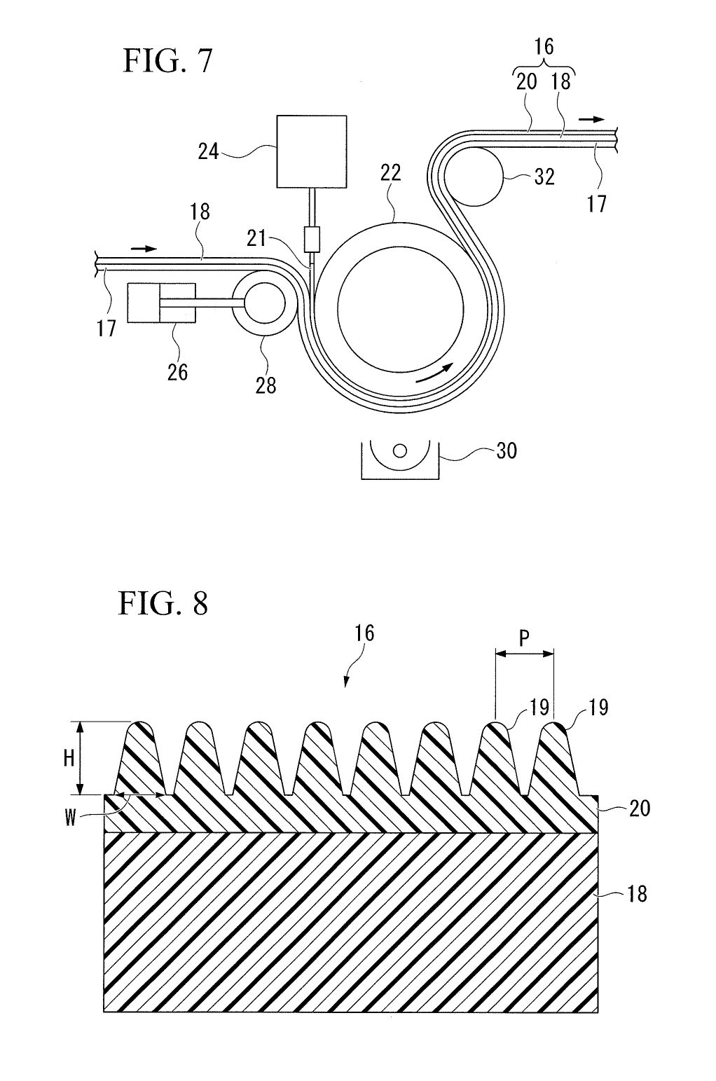

The transparent film is prepared in the following manner by using, for example, a device for preparation shown in FIG. 7.

Between the roll-like mold 22 which has the inverse micro structure including a plurality of concave portions (not shown) on the surface thereof and a belt-like base material film 18 which moves along the surface of the mold 22 and is supported from the back surface side thereof by a belt-like supporting film 17, an active energy beam-curable resin composition 21 is supplied from a tank 24.

Between the mold 22 and a nip roll 28 for which nip pressure has been adjusted by a pneumatic cylinder 26, the base material film 18 supported by the supporting film 17 and the active energy beam-curable resin composition 21 are nipped. The active energy beam-curable resin composition 21 is caused to uniformly pass between the base material film 18 and the mold 22 and to fill the inside of the concave portions of the mold 22 simultaneously.

While the active energy beam-curable resin composition 21 is sandwiched between the mold 22 and the base material film 18, the active energy beam-curable resin composition 21 is irradiated with an active energy beam from the supporting film 17 side, by an active energy beam emitting device 30 which is disposed below the mold 22. The active energy beam-curable resin composition 21 is cured in this manner, whereby a cured layer 20 to which the plurality of concave portions on the surface of the mold 22 has been transferred is formed.

As the active energy beam emitting device 30, a high pressure mercury lamp, a metal halide lamp, and the like are preferable, and in this case, the amount of the light energy emitted is preferably 100 to 10000 mJ/cm².

The base material film 18 in which the cured layer 20 has been formed on the surface thereof is peeled together with the supporting film 17 by a peeling roll 32, and as a result, a transparent film 16 supported by the supporting film 17 is obtained.

The supporting film 17 is optionally peeled off from the back surface of the base material film 18.

(Micro Protrusion and Recess Face Structure)

The transparent film 16 obtained in the above manner includes the base material film 18 and the cured layer 20 which is formed on the surface of the base material film 18 and has the micro protrusion and recess face structure including a plurality of convex portions 19, as shown in FIG. 8.

It is preferable that the plurality of convex portions 19 form a so-called moth-eye structure in which a plurality of bumps (convex portions) with a pyramidal shape or the like is arranged at intervals which are equal to or shorter than the wavelength of the visible rays. It is known that the moth-eye structure becomes effective means for preventing reflection since it is difficult for the refractive index to continuously increase from the refractive index of air to the refractive index of material in this structure.

The average period between the convex portions 19 is preferably equal to or less than the wavelength of the visible rays, that is, 400 nm or less, more preferably 200 nm or less, and particularly preferably 150 nm or less. Herein, the average period between the convex portions 19 is obtained by observing a cross-section of the cured layer 20 with an electron microscope, measuring an interval P (a distance between the center of a convex portion 19 and the center of the next convex portion 19) between the neighboring convex portions 19 for 50 spots, and averaging the values.

When the convex portions 19 are formed using a mold of anodized alumina, the average period between the convex portions 19 is becomes about 100 nm, which is thus preferable.

The average period between the convex portions 19 is preferably 25 nm or longer in terms of easiness of formation of the convex portions 19. Moreover, the average period between the convex portions 19 is preferably 80 nm or longer, more preferably 130 nm or longer, and particularly preferably 150 nm or longer, in that an effect of catching light of large incidence angle caused by diffraction of light can be expected in the period. The light incident to a solar cell greatly varies with time and seasons. Accordingly, the transparent film 16 that can also be expected to have an effect of catching light of high incidence angle caused by the diffraction of light is useful as a reflection preventive film of a protection plate of the solar cell and a transparent baseboard for a transparent electrode, for example.

A ratio (H/W) between a height H of the convex portions 19 and a width W of the bottom portion of the convex portions 19 is 1.5 or higher, preferably 2.0 or higher, and still more preferably 3.0 or higher. If H/W is 1.5 or higher, it is possible to suppress the reflectance to be low in the entire region including the visible ray region and the near infrared ray region. H/W is preferably 5.0 or lower in terms of the mechanical strength of the convex portions 19.

H is preferably 100 to 500 nm, and more preferably 150 to 400 nm. If the height of the convex portions 19 is 100 nm or more, the reflectance becomes sufficiently low, and wavelength dependency of the reflectance is small. If the height of the convex portions 19 is 500 nm or less, the mechanical strength of the convex portions 19 becomes excellent.

H and W can be measured by observing a cross-section of the cured layer 20 with an electron microscope.

W is the width of the surface which is at the same plane as the bottom portion of concave portions formed around the convex portions 19 (hereinafter, referred to as a standard plane).

H is height from the standard plane to the top of the convex portions 19.

It is possible to adjust H/W by appropriately selecting a condition for preparing a mold having the anodized alumina on the surface thereof, the viscosity of the active energy beam-curable resin composition to be filled in the micropores (concave portions) of the mold, and the like (see JP-A-2008-197216).

A difference between the refractive index of the cured layer 20 and the refractive index of the base material film 18 is preferably 0.2 or less, more preferably 0.1 or less, and particularly preferably 0.05 or less. If the difference in the refractive index is 0.2 or less, reflection occurring in the interface between the cured layer 20 and the base material film 18 is suppressed.

It is known that when the moth-eye structure is used for the surface, if the surface includes a hydrophobic material, super-water repellency is obtained by the lotus effect, and if the surface includes a hydrophilic material, super-hydrophilicity is obtained.

When the material of the cured layer 20 is hydrophobic, the water contact angle of the surface of the moth-eye structure is preferably 90° or more, more preferably 100° or more, and particularly preferably 110° or more. If the water contact angle is 90° or more, it is difficult for water stains to be attached, hence sufficient antifouling property is expressed. Moreover, it is difficult for water to be attached, hence anti-icing property can be expected.

When the material of the cured layer 20 is hydrophilic, the water contact angle of the surface of the moth-eye structure is preferably 25° or less, more preferably 23° or less, and particularly preferably 21° or less. If the water contact angle is 25° or less, dirt attached on the surface is washed away with water, and it is difficult for oil stains to be attached, hence sufficient antifouling property is expressed. The water contact angle is preferably 3° or more in that the deformation of the moth-eye structure caused by the water absorption of the cured layer 20 and the increase in the reflectance caused by the deformation are suppressed in the angle.

(Product Having Micro Protrusion and Recess Face Structure on the Surface Thereof)

By attaching the transparent film to the body of various products, products having the micro protrusion and recess face structure on the surface thereof are obtained.

As the body of the product, those are preferable in which at least the surface thereof to be attached to the transparent film is configured with the same type of materials as the acrylic film or the TAC film as the base material film or materials having about the same degree of refractive index as the acrylic film or the TAC film.

Examples of the product having the micro protrusion and recess face structure on the surface thereof include reflection preventive products, products used for water repellency, cell culture substrata, products used for hydrophilicity, construction supplies, and the like.

(Operation and Effect)

The method of preparing the transparent film of the present invention described as above includes (I) a step of sandwiching an active energy beam-curable resin composition including a polymerizable compound and a photopolymerization initiator which can initiate polymerization of the polymerizable compound by absorbing light of a wavelength of 340 nm or longer between the surface of a base material film which is supported from the back surface side thereof by a supporting film having 10% or lower light transmissivity in a wavelength range of 190 to 310 nm and having 60% or higher light transmissivity in a wavelength range of 340 to 900 nm, and a mold which has an inverse structure of the micro protrusion and recess face structure on the surface thereof having been treated with an organic mold release agent, (II) a step of obtaining the transparent film which is supported from the back surface side thereof by the supporting film by means of irradiating the active energy beam-curable resin composition with ultraviolet rays from the supporting film side and forming the cured layer by curing the active energy beam-curable resin composition, and (III) a step of separating the transparent film which is supported from the back surface side thereof by the supporting film and the mold, and in this method, the active energy beam-curable resin composition is irradiated with ultraviolet rays from the supporting film side.

Accordingly, it is possible to reduce the light having a wavelength of 310 nm or less which reaches the mold surface and deteriorates and degrades the organic mold release agent, without excessively reducing the light having a wavelength of 340 nm or more which is emitted to the active energy beam-curable resin composition and is necessary for polymerizing the polymerizable compound. As a result, it is possible to stably prepare the transparent film in which the cured layer having the micro protrusion and recess face structure is formed on the surface of the base material film such as the acrylic film, TAC film, and the like.

In the method of preparing the transparent film of the present invention described as above, when the transparent film in which the cured layer having the micro protrusion and recess face structure is formed on the surface of the base material film is prepared by a so-called roll-to-roll method, the base material film having a tensile strength at 70° C. of 5 MPa to 40 MPa is supported from the back surface side thereof by the supporting film having a tensile strength at 70° C. of more than 40 MPa. Consequently, it is possible to continuously prepare the transparent film in which the cured layer having the micro protrusion and recess face structure is formed on the surface of the base material film having a weak tensile strength, without breakage of the film.

<Transparent Film>

The transparent film of the present invention is a transparent film in which the cured layer having the micro protrusion and recess face structure is formed on the surface of the base material film which is supported from the back surface side thereof by the supporting film.

The base material film is a long resin film having a tensile strength at 70° C. of 5 MPa or more. Preferably, the base material film is a long resin film having a tensile strength at 70° C. of 5 MPa to 40 MPa. As the base material film, an acrylic film or a TAC film is preferable.

Preferably, the supporting film is a long resin film having a tensile strength at 70° C. of more than 40 MPa. As the supporting film, a PET film is preferable.

The adhesion between the base material film and the supporting film is preferably 0.005 to 50 N/25 mm.

In the transparent film of the present invention, the base material film having a tensile strength at 70° C. of 5 MPa or more is supported from the back surface side thereof by the supporting film. Therefore, the transparent film becomes a continuous film without breakage, even though the cured layer having the micro protrusion and recess face structure is formed on the surface of the base material film having a weak tensile strength.

### EXAMPLES

Hereinafter, examples of the present invention will be described in detail, but the present invention is not limited thereto.

(1) First, how the influence of ultraviolet rays on the organic mold release agent varies with the types of the base material film was investigated.

(Mold a)

An aluminum plate (purity of 99.99%) having 50 mm square sides was mirror-polished.

Step (a):

The aluminum plate was anodized for 6 hours in of an aqueous oxalic acid solution of 4.5% by mass under conditions of direct current: 40 V and temperature: 16° C.

Step (b):

The aluminum plate in which an oxidized layer had been formed was dipped in an aqueous mixed solution including 6% by mass of phosphoric acid and 1.8% by mass of chromic acid for 6 hours at 70° C., thereby removing the oxidized layer.

Step (c):

The aluminum plate was anodized for 30 seconds in an aqueous oxalic acid solution of 2.7% by mass under conditions of direct current: 40 V and temperature: 16° C.

Step (d):

The aluminum plate in which the oxidized layer had been formed was dipped in an aqueous phosphoric acid solution of 5% by mass for 8 minutes at 32° C., thereby enlarging the micropore diameter.

Step (e):

Steps (c) and (d) were repeated 5 times in total, thereby obtaining a flat plate-like mold a in which anodized alumina having micropores of an approximately conical shape with an average period: 100 nm and a depth: 240 nm had been formed on the surface of the mold.

The mold a was dipped in 0.1% by mass of a dilute solution of OPTOOL DSX (manufactured by Daikin Chemical Products Distributor Corporation) for 10 minutes at ambient temperature and then pulled out. The mold a was air-dried overnight, thereby obtaining the mold a treated with an organic mold release agent.

(Active Energy Beam-Curable Resin Composition A)

45 parts by mass of a condensation reaction mixture of succinic acid/trimethylolethane/acrylic acid (molar ratio of 1:2:4), 45 parts by mass of 1,6-hexandiol diacrylate (manufactured by OSAKA ORGANIC CHEMICAL INDUSTRY LTD.), 10 parts by mass of radically polymerizable silicone oil (manufactured by Shin-Etsu Chemical Co., Ltd, X-22-1602), 3 parts by mass of 1-hydroxycyclohexyl phenyl ketone (manufactured by Ciba Specialty Chemicals Ltd., IRGACURE® 184, having an absorption wavelength range at a wavelength of 340 nm or more), and 0.2 parts by mass of bis(2,4,6-trimethylbenzoyl)-phenyl phosphinoxide (manufactured by Ciba Specialty Chemicals Ltd., IRGACURE® 819, having an absorption wavelength range at a wavelength of 340 nm or more) were mixed, thereby obtaining an active energy beam-curable resin composition A.

(Transfer Test)

The ultraviolet-curable resin composition A was placed on the surface of the mold a having been treated with the organic mold release agent and optionally treated with ultraviolet irradiation, followed by lamination using a PET film (manufactured by TOYOBO CO., LTD., product name: A4300, thickness: 188 μm), and the resultant was irradiated with ultraviolet rays from the top of the film with an energy of 800 mJ/cm² so as to be cured. Thereafter, the film was peeled off from the mold.

The above operations were repeated until it was difficult to peel off the film from the mold, and the number of times of the operation repeated to reach such a stage was taken as the number of times of transfer.

### Test Example 1

The mold a having been treated with the organic mold release agent was subjected to the transfer test without being subjected to ultraviolet irradiation. The results are shown in Table 1.

### Test Example 2

The surface of the mold a having been treated with the organic mold release agent was irradiated with ultraviolet rays with an energy of 800 mJ/cm² over a PET film (manufactured by TOYOBO CO., LTD., product name: A4300, thickness: 188 μm). The ultraviolet irradiation was repeated 500 times in total.

The mold a having undergone the ultraviolet irradiation was subjected to the transfer test. The results are shown in Table 1.

### Test Example 3

A PET film (manufactured by TOYOBO CO., LTD., product name: A4300, thickness: 188 μm) was placed on the surface of the mold a having been treated with the organic mold release agent, and the resultant was irradiated with ultraviolet rays with an energy of 800 mJ/cm² from the top of the film over the PET film (manufactured by TOYOBO CO., LTD., product name: A4300, thickness: 188 μm). The irradiation was repeated 500 times in total.

The mold a having undergone the ultraviolet irradiation was subjected to the transfer test. The results are shown in Table 1.

### Test Example 4

An acrylic film (manufactured by Mitsubishi Rayon Co., Ltd, product name: Acrypren® HBK002, thickness: 200 μm) was placed on the surface of the mold a having been treated with the organic mold release agent, and the resultant was irradiated with ultraviolet rays with an energy of 800 mJ/cm² from the top of the film over the PET film (manufactured by TOYOBO CO., LTD., product name: A4300, thickness: 188 μm). The irradiation was repeated 500 times in total.

The mold a having undergone the ultraviolet irradiation was subjected to the transfer test. The results are shown in Table 1.

TABLE 1

| | Ultraviolet | | |
|---|---|---|---|
| | irradiation | | Transfer test |
| | Present/ | | Number of times of |
| | Absent | Film | transfer |
| Test example 1 | Absent | — | 304 |
| Test example 2 | Present | Absent | 0 |
| Test example 3 | Present | PET | 235 |
| Test example 4 | Present | Acryl | 0 |

As shown from the results in Table 1, since the acrylic film could almost not reduce the ultraviolet rays, the deterioration and degradation of the organic mold release agent were marked in the mold irradiated with the ultraviolet rays from the top of the acrylic film, which was the exactly same result as obtained from the mold irradiated with the ultraviolet rays without the base material film.

On the other hand, the deterioration and degradation of the organic mold release agent were suppressed in the mold irradiated with the ultraviolet rays from the top of the PET film, which was a state close to the mold that had not been irradiated with the ultraviolet rays.

(2) Method of Preparing Transparent Film:

Next, the transparent film was prepared and evaluated.

(Micropores of Anodized Alumina)

A part of the anodized alumina was cut, and platinum was vapor-deposited on the cross-section thereof for 1 minute. The cross-section was observed using a field emission-type scanning electron microscope (manufactured by JEOL Ltd., JSM-7400F) under conditions of an accelerating voltage: 3.00 kV, whereby intervals between the micropores and the depth of the micropores were measured. Each of the measurements was performed for 50 spots, and the average was determined

(Convex Portion of Cured Layer)

The platinum was vapor-deposited to a fracture cross-section of the cured layer for 5 or 10 minutes, and the cross-section was observed using a field emission-type scanning electron microscope (manufactured by JEOL Ltd., JSM-7400F) under conditions of an accelerating voltage: 3.00 kV, whereby average intervals between the convex portions and the height of the convex portion were measured. Each of the measurements was performed for 5 spots, and the average was determined

(Tensile Strength)

To measure the tensile strength at 70° C. of each film, a tensile tester (manufactured by Shimadzu Corporation., AG-1S10 kN) was used. A sample was cut into a strip shape having a width of about 5 mm and gripped by a chuck so as to yield a valid test length of 20 mm. Thereafter, a thermostatic bath (manufactured by Shimadzu Corporation., TCL-N220) was adjusted to 70° C., and then the tensile strength was measured at a tensile rate of 40 mm/min, whereby a stress-strain curve was obtained. The tensile strength at 70° C. was determined in this manner.

(Adhesion)

To measure the adhesion between the base material film and the supporting film, a Tensilon tester for tensile strength test (manufactured by ORIENTEC Co., LTD, Tensilon RTC-1210) was used. By setting transparent film cut into 25 mm×30 cm and using 10 N of load cells, the adhesion between the base material film and the supporting film was measured based on JIS Z0237.

(Reflectance)

A relative reflectance of the surface of the cured layer was measured using a spectrophotometer (manufactured by Hitachi, Ltd., U-4000) at an incidence angle: 5° and a wavelength range of 380 to 780 nm.

(Mold b)

An aluminum ingot with a purity of 99.9% was forged, and a cylindrical aluminum prototype which was cut into a diameter of 200 mm and a length of 350 mm, had no trace of rolling, and had an average crystal grain size of 40 μm was subjected to fabric polishing. Thereafter, the resultant was subjected to electrolytic polishing in a mixed solution of perchloric acid/ethanol (volume ratio: 1/4) to render the surface into a mirror surface.

Step (a):

The aluminum prototype was anodized for 30 minutes in a 0.3 M aqueous oxalic acid solution under conditions of a direct current of 40 V and temperature of 16° C.

Step (b):

The aluminum prototype in which an oxidized layer having a thickness of 3 μm had been formed was dipped in an aqueous mixed solution including 6% by mass of phosphoric acid/1.8% by mass of chromic acid, thereby removing the oxidized layer.

Step (c):

The aluminum prototype was oxidized for 30 seconds in an 0.3 M aqueous oxalic acid solution under conditions of a direct current of 40 V and temperature of 16° C.

Step (d):

The aluminum prototype in which the oxidized layer had been formed was dipped in of an aqueous phosphoric acid solution of 5% by mass for 8 minutes at 30° C., thereby enlarging the micropore diameter.

Step (e):

Steps (c) and (d) were repeated 5 times in total, thereby obtaining roll-like molds b and c in which anodized alumina having micropores of an approximately conical shape with an average period of 100 nm and a depth of 200 nm had been formed on the surface of the molds.

When the micro protrusion and recess face structure of the mold c was visually confirmed, a macro-concave and convex structure at the crystal grain boundary could not be confirmed.

The molds b and c were dipped in 0.1% by mass of a dilute solution of OPTOOL DSX (manufactured by Daikin Chemical Products Distributor Corporation) for 10 minutes at ambient temperature and then pulled out. The mold b was air-dried overnight, thereby obtaining the molds b and c treated with an organic mold release agent.

### Example 1

The transparent film was prepared using the device for preparation shown in FIG. 7.

As the roll-like mold 22, the mold b was used.

As the active energy beam-curable resin composition 21, the active energy beam-curable resin composition A was used.

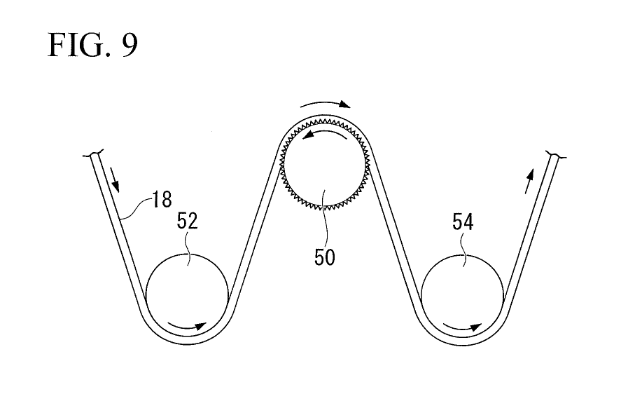

As the base material film 18 supported by the supporting film 17, the one obtained by attaching a PET film (manufactured by Sun A Kaken Co., Ltd., product name: SAT116, thickness: 38 μm) to the back surface of an acrylic film (manufactured by Mitsubishi Rayon Co., Ltd, product name: Acrypren® HBK002, thickness: 50 μm) was used. As the acrylic film, the one having a surface which was roughened by using a scratch blast device as shown in FIG. 9 was used. The device includes a brush roll 50 having a concave and convex shape including a titanium oxide on the surface thereof and tension rolls 52 and 54 arranged in front and rear of the brush roll 50, and the surface of the acrylic film was roughened while the brush roll 50 was rotated in an inverse direction of the movement direction of an acrylic film 18. The device can adjust the surface roughness by changing the tension applied to the acrylic film 18 by means of the tension rollers 52 and 54, and the arithmetic mean roughness Ra of the acrylic film was 0.134 μm, the maximum height Ry thereof was 5.35 μm (calculated using a scanning type white interferometer 3 dimensional profiler system “New View 6300”: manufactured by Zygote Corporation), and the external haze thereof was 9.1% (measured based on JIS K7136 by using a hazemeter manufactured by Suga Test Instruments Co., Ltd.).

The coating layer of the active energy beam-curable resin composition A was irradiated with ultraviolet rays of a cumulative light amount of 800 mJ/cm² from the supporting film 17 side, whereby the active energy beam-curable resin composition A was cured.

It was possible to continuously and stably prepare 500 m of the transparent film.

The average period between the convex portions of the obtained transparent film was 100 nm, the height of the convex portions was 200 nm, and the reflectance at the wavelength of 380 to 700 nm was 0.1 to 0.3%.

The weather resistance of the obtained transparent film was investigated by the SWOM test.

The SWOM test was performed for 660 hours under conditions of a temperature of a BPT black panel of 63±3° C., an internal humidity of a bath of 50±5%, precipitation of 18 minutes within 120 minutes, and a cycle of 78 hours.

As a result, peeling of the cured layer having the micro protrusion and recess face structure was not confirmed.

### Example 2

The transparent film was prepared in the same manner as Example 1, except that a PET film provided with a mold release layer was attached to the acrylic film by using an acrylic forming agent, and that the surface of the acrylic film was not roughened. As a result, it was possible to continuously and stably prepare the same transparent film as in Example 1.

### Example 3

As the base material film 18, an acrylic film (manufactured by Mitsubishi Rayon Co., Ltd, product name: Acrypren® HBS010, thickness: 200 μm, tensile strength at 70° C.: 30 MPa) was used. To the back surface of the acrylic film, a PET film (manufactured by Sun A Kaken Co., Ltd., product name: SAT-116T, thickness: 38 μm, tensile strength at 70° C.: 43 MPa) provided with an adhesive was attached as the supporting film 17. The adhesion between the base material film 18 and the supporting film 17 was 0.015 N/25 mm. In addition, the surface of the acrylic film was roughened in the same manner as Example 1, and the arithmetic mean roughness Ra was 0.066 μm, the maximum height Ry was 3.43 μm, and the haze was 3.6%.

The coating layer of the active energy beam-curable resin composition A was irradiated with ultraviolet rays of a cumulative light amount of 1100 mJ/cm² from the supporting film 17 side, whereby the active energy beam-curable resin composition A was cured. As a result, it was possible to continuously and stably prepare 500 m of the transparent film. The average period between the convex portions of the obtained transparent film was 100 nm, the height of the convex portions was 200 nm, and the reflectance of the wavelength at 380 nm to 700 nm was 0.1% to 0.3%. [Example 4]

As the base material film 18, an acrylic film (manufactured by Mitsubishi Rayon Co., Ltd, product name: Acrypren® HBK002, thickness: 50 μm, tensile strength at 70° C.: 30 MPa) was used. To the back surface thereof, an adhesive (manufactured by Sumiron, RA600N) provided with the acrylic supporting film 17 was attached so as to yield a thickness of 25 μm. The tensile strength at 70° C. of the supporting film 17 was measured to be 45 MPa. The adhesion between the base material film 18 and the supporting film 17 was 0.030 N/25 mm. In addition, the surface of the acrylic film was roughened in the same manner as Example 1.

Next, the transparent film was prepared in the same manner as Example 3. As a result, it was possible to continuously prepare 600 m of the transparent film. The average period between the convex portions of the obtained transparent film was 100 nm, and the height of the convex portions was 200 nm, and the reflectance at a wavelength a 380 nm to 700 nm was 0.1% to 0.3%.

### Comparative Example 1

The transparent film was attempted to be prepared in the same manner as Example 1, except that an acrylic film (manufactured by Mitsubishi Rayon Co., Ltd, product name: Acrypren® HBK010, thickness: 200 μm) that was not supported from the back surface thereof by a PET film was used. However, defective peeling occurred between the transparent film and the mold, hence the transparent film could not be prepared.

### Comparative example 2

The transparent film was attempted to be prepared in the same manner as Example 3, except that the back surface of the acrylic film was not supported by the PET film. However, the acrylic film was broken soon, hence the transparent film could not be prepared.

### Comparative Example 3

The transparent film was prepared in the same manner as Example 1, except that PET (WE97A manufactured by Mitsubishi Plastics, Inc., thickness of 38 μm) was used as the base material film. It was possible to continuously and stably prepare the transparent film.

The SWOM test was performed on this film in the same manner as Example 1, and the peeling of the cured layer having the micro protrusion and recess face structure was visually confirmed.

### INDUSTRIAL APPLICABILITY

The transparent film of the present invention is useful as a reflection preventive film, water repellent film, hydrophilic film, film for construction supplies, cell culture substrata, and the like.

### BRIEF DESCRIPTION OF THE REFERENCE SYMBOLS

16: transparent film
17: supporting film
18: base material film
19: convex portion (micro protrusion and recess face structure)
20: cured layer
21: active energy beam-curable resin composition
22: mold
36: micropores (inverse structure)

1. A method of preparing a transparent film in which a cured layer having a micro protrusion and recess face structure is formed on a surface of a base material film, comprising:
(I) a step of sandwiching an active energy beam-curable resin composition comprising a polymerizable compound and a photopolymerization initiator which can initiate polymerization of the polymerizable compound by absorbing light of a wavelength of 340 nm or longer between a surface of a base material film which is supported from a back surface side thereof by a supporting film having 10% or lower light transmissivity in a wavelength range of 190 to 310 nm and having 60% or higher light transmissivity in a wavelength range of 340 to 900 nm, and a mold which has an inverse structure of the micro protrusion and recess face structure on a surface thereof having been treated with an organic mold release agent;
(II) a step of obtaining the transparent film which is supported from the back surface side thereof by the supporting film by means of irradiating the active energy beam-curable resin composition with ultraviolet rays from the supporting film side and forming the cured layer by curing the active energy beam-curable resin composition; and
(III) a step of separating the transparent film which is supported from the back surface side thereof by the supporting film and the mold.

2. A method of preparing a transparent film in which a cured layer having a micro protrusion and recess face structure is formed on a surface of a base material film, comprising:
while a base material film which is supported from a back surface thereof by a supporting film having a tensile strength at 70° C. of greater than 40 MPa and has a tensile strength at 70° C. of 5 MPa to 40 MPa is moved along a surface of a rotating roll-like mold which has an inverse structure of the micro protrusion and recess face structure on a surface thereof, sandwiching an active energy beam-curable resin composition between a surface of the base material film and a surface of the roll-like mold; and
obtaining a transparent film which is supported from the back surface thereof by the supporting film by forming a cured layer to which the inverse structure has been transferred, by means of curing the active energy beam-curable resin composition by irradiating the active energy beam-curable resin composition with active energy beams.

3. The method of preparing the transparent film according to claim 1,
wherein the base material film is a film comprising a (meth)acrylic resin or triacetyl cellulose.

4. The method of preparing the transparent film according to claim 1,
wherein an adhesion between the base material film and the supporting film is 0.005 to 50 N/25 mm.

5. A transparent film in which a cured layer having a micro protrusion and recess face structure is formed on a surface of a base material film which is supported from a back surface side thereof by a supporting film, having a tensile strength at 70° C. of the base material film is 5 MPa or more.

6. The transparent film according to claim 5,
wherein an adhesion between the base material film and the supporting film is 0.005 to 50 N/25 mm.

7. The transparent film according to claim 5,
wherein the base material film is a film comprising a (meth)acrylic resin or triacetyl cellulose.

8. The method of preparing the transparent film according to claim 2,
wherein the base material film is a film comprising a (meth)acrylic resin or triacetyl cellulose.

9. The method of preparing the transparent film according to claim 2,
wherein an adhesion between the base material film and the supporting film is 0.005 to 50 N/25 mm.

10. The transparent film according to claim 6,
wherein the base material film is a film comprising a (meth)acrylic resin or triacetyl cellulose.
